(19) United States
(12) Patent Application Publication
(10) Pub. No.: US 2025/0091916 A1
(43) Pub. Date: Mar. 20, 2025

(54) WATER STERILISER

(71) Applicant: AUGUSTO ERIC REIJER PICOZZI, Los Andes, Region de Valparaiso (CL)

(72) Inventor: AUGUSTO ERIC REIJER PICOZZI, Los Andes, Region de Valparaiso (CL)

(21) Appl. No.: 18/283,771

(22) PCT Filed: Feb. 28, 2022
(86) PCT No.: PCT/CL2022/050018

§ 371 Date: Jun. 14, 2024

(30) Foreign Application Priority Data
Mar. 30, 2021 (CL) 0810-2021

(51) Int. Cl. C02F 1/50; B01D 39/16; C02F 1/00; C02F 103/42

(52) U.S. Cl. CPC C02F 1/50; B01D 39/1623; C02F 1/001; B01D 2239/0618; C02F 2103/42; C02F 2201/004; C02F 2303/04; C02F 2303/14; C02F 2303/16

(57) ABSTRACT

The present invention relates to a container (2) containing copper flakes for disinfecting water. For easier maintenance, the container has an upper central opening and a lower central opening (3), each of said openings including a retention vessel (5) connected to same with jaw clamps (10) on flanges (9); and a rubber seal (8) is installed between the two clamps. A circular mesh (11) with the same diameter as the inside of the retention vessel is positioned on a peripheral projection (12) of the retention vessels, preventing the filter medium (6) from exiting through the tube (20) in the cover (14) of the container. Moreover, the rubber seals (8) rest on an inner peripheral support (13), forming a seal with the squeezing of the ring of the cover, the lower edge of which traps the circular mesh (11), compacting the filter medium (6) and thereby preventing the copper flake from exiting the container (2).

### BACKGROUND OF THE STATE OF THE ART

Utility model relates to a copper-based water sterilizer device consisting of a container containing small flakes of low thickness pure metallic copper to disinfect the water to be treated from pathogenic microorganisms. The container containing the small metallic copper flakes is cylindrical in shape and has an upper and lower central opening when hold in vertical position. The water enters from the lower opening and floods the chamber containing the copper flakes. During the operation, the vertical position will allow the water under treatment to drag the air remaining in the device and drain it through the upper opening and to the outside.

In both openings of the cylindrical container retention vessels containing a filtration membrane such as polyester fleece is connected to prevent the copper flakes to exit the device with the water flow. The retention vessel connected to the lower opening will retain the copper in case of a reverse flow.

In one embodiment, to treat water for recreational use, for example in a bathtub, pool or similar container, the system will recycle the same water several times through the sterilizer device. Frequent contact between the different microorganisms in the water and the copper will produce its elimination.

In one embodiment for specialized agricultural irrigation water, the water pass through the sterilizer just once. To achieve an efficient removal, a much higher volume container for the copper flakes will be necessary compared to the recreational water so the irrigation water can have enough time in the container to reach an efficient sterilization.

In one embodiment for human consumption, the size of the sterilizer equipment will be defined according to the requirements of both supply and use, namely the time the water spent in contact with the metallic copper flakes.

The antimicrobial property of the pure metallic copper is supported by several research studies performed and published by different scientific institutions.

As for the state of the art, we can quote the invention patent CLN°57259, which relates to a procedure for the manufacturing of metallic copper flakes of very low thickness but large area in relation to its mass using a pure copper cathode as raw material which laminated shape allows a large contact area with passing water for recreational, irrigation or human consumption purposes in order to disinfect water from bacteria or other microorganisms. The manufacturing procedure consists of milling pure copper cathodes or copper plates (2) with a cylindrical burner (3) rotating at high revolutions per minute. The uniform thickness of the copper scale (1) is regulated by varying the distance of the plane of the initial cathode support platform (4) in parallel with the upper horizontal tangent of the cylindrical cutter (3). The pure copper plate or cathode (2) is pushed from the initial cathode support platform (4) towards the final cathode support platform (5) located in the same horizontal tangent plane of the cylindrical cutter (3). When the plate or cathode of pure copper (2) has passed completely over the cylindrical cutter (3), it pushes back in reverse to position itself again on the initial cathode support platform (4) and so on the flakes of copper (1) until the plate or cathode of pure copper (2) is consumed.

Another invention, patent application CLN°201300176 which refers to an antimicrobial filter designed as a vertical cylindrical container covered and sealed in both ends, filled with pure metallic copper flakes or chips trapped between two rigid grids and a retention barrier in the upper end or water outlet to avoid dragging the copper particles to the outside and maintaining an empty small cylindrical section in the upper and lower part of the cylinder equipped with a feeding pipe going through the filling of copper flakes or chips to deposit the water in the lower end cylindrical section and a water outlet pipe in the empty cylindrical section of the upper end of the cylinder characterized in that the design of the antimicrobial filter 34 by being fed with water through the inlet pipe 7 will flood the water inlet chamber 9 and continue flooding and rising the level of water through the copper flakes and chips 1 in the copper deposit 13, reaching full copper-water contact and thus disinfecting, eliminating or neutralizating the effect of bacteria, viruses, fungus, algae and other antimicrobial agents. Once the copper deposit 13 has been completely flooded and if feeding is maintained, the water will flood the outlet chamber 10 and finally exit through the outlet pipe 8 to be used for human consumption or use.

The utility model “Water sterilizer” has the purpose of creating a product of immediate and simple application both in implementation and maintenance.

The following tables show the functional advantages as compared with the current state of the art:

| UTILITY MODEL | PATENT INVENTION |
|---|---|
| “WATER STERILIZER” | APPLICATION CL 201300176 |
| Feeding by lower end and discharge by | Both feeding and discharge through |
| upper end. | the upper part requires an internal |
| | distribution of flow. |
| Comparatively, much simpler assembly of | Comparatively, more complex |
| water sterilizer | assembly of the water sterilizer. |
| Cleaning the water inlet and outlet | Cleaning of one or both retention |
| retention system only requires decoupling | systems require to dismantle the whole |
| the retention vessel | equipment. |
| Replacing copper flakes can be | Replacing copper flakes require to |
| performed by removing one retention | dismantle the whole device. |
| vessel | |
| Comparatively, the “water sterilizer” has less | Comparatively, the high quantity of |
| components which derives in lower costs of | components in the “antimicrobial |
| both manufacturing and maintenance | filter” derive in higher costs of both |
| | manufacturing and maintenance |
| UTILITY MODEL | PATENT INVENTION APPLICATION |
| “WATER STERILIZER” | CL 201101455 |
| The format of the device allows use in | The format only allows its application in |
| recreational water systems, agricultural | recreational water systems. |
| irrigation systems and human consumption | |
| systems as a replacement for drinking | |
| water. | |
| Its format allows an easy implementation in | Its format allows implementation in large |
| recreational water devices such as hot | volume recreational water such as static |
| tubs, jacuzzi, inflatable pools and the like | domestic or private pools. |
| Copper flakes in the container cannot be | Copper flakes of the sand filter cannot |
| washed away by water but are retained by | be washed out by water but are retained |
| the upper retention vessel. The lower | by the sand in the lower outlet. The |
| retention vessel avoids the copper to be | upper sand retains dirt. |
| dragged in reverse flow. | |
| Cleaning the retention vessel requires to | Cleaning the sand in the filter require |
| remove just that unit. | backwash with water. |
| Changing the copper flakes only requires | Lifespan of the sand is shorter than the |
| removing the upper or lower retention | one of the copper flakes. Copper is lost |
| vessel. | every time the sand is changed. |
| Field of application or recreational market | Limited field of applications. Difficult to |
| is wide. It can even be coupled after a | be used in hot tubs, jacuzzi or portable |
| sand filter. | pools. |
| Even though the same quantity of copper | Even though the same quantity of copper |
| is used, the equipment is lighter | is used, the equipment is heavier |
| and smaller. Lower cost | because of the sand inside and its |
| | higher volume. Higher cost. |

### BRIEF DESCRIPTION OF DRAWINGS

To better understand the basic characteristics of the utility model, the water sterilizer device will be described according to the drawings that constitute an integral part of this invention without restrictions to any obvious modifications that may arise, wherein:

FIG. N°1 shows an elevation view in longitudinal section of the copper flakes-based water sterilizer with the retention components located both in the upper outlet opening of the copper flakes container and the part applicable to the lower water inlet opening of the utility model.

FIG. N°2 shows a longitudinal section view of an upper section of the copper retention system located in the outlet opening of the copper flakes container also applicable to the lower inlet opening to retain solids in suspension and avoid dragging the copper flakes in the event of a reverse flow of the utility model.

FIG. N° 2a shows a lateral elevation view both in the lower cross-sectional and longitudinal view and the retention component of the lower copper flakes of the utility model.

FIG. N°3 shows a front elevation exploded view of all the components of the copper retention system in the water outlet, the upper part, and the components of the suspended solids retention system in the water inlet, lower part of the metallic copper flakes container of the utility model.

FIG. 3a shows a front elevation exploded view of all the components of the suspended solids retention system, lower part of the water sterilizer device of the utility model.

### DESCRIPTION OF THE UTILITY MODEL

Considering FIG. 1, the utility model of the “Water sterilizer” device (1) based on copper flakes or chips (4), comprises a copper cylindrical barrel-like container (2) with a central upper opening (3) and a lower central opening (3a) which serve as water inlet through the lower opening (3a) and water outlet through the upper opening (3), Both openings (3) and (3a) have been also designed to introduce the copper flakes or chips (4) in the container (2) of the sterilizer device (1).

The water sterilizer device (1) based on copper flakes or chips works in a vertical position with respect to its openings (3) y (3a), in such a way the water entering through the lower opening (3a) will drag all the air contained between the copper flakes or chips (4) in the container (2), and remove it through the upper opening (3) out of the water sterilization device (1), maintaining full contact between the water and the copper flakes or chips (4), thus producing the sterilization of water.

To avoid copper flakes to be dragged (4) out of the container (2), the water sterilization device (1) based on copper flakes connects its upper opening (3) with an upper retention vessel (5) and a lower retention vessel (5a) to its lower opening (3a). Those are identical retention vessels and once assembled they must be fastened with bolts or upper (10) and lower clamps (10a) to an upper (9) and lower flange (9a) holding in such way the metallic copper flakes or chips (4) to the container (2). The function of the upper (5) and lower retention vessels (5a) is preventing the water to drag the copper flakes to the outside and avoiding any foreign particle to enter through the lower opening (3a).

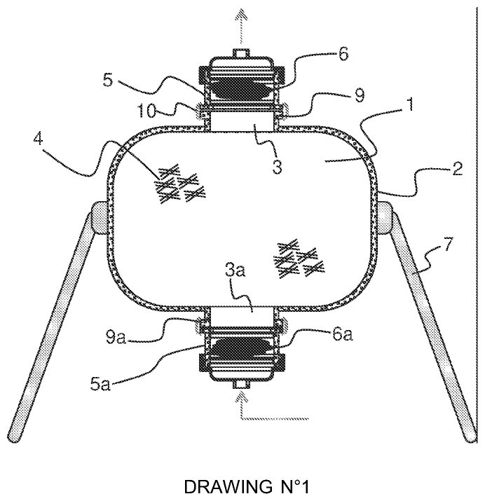

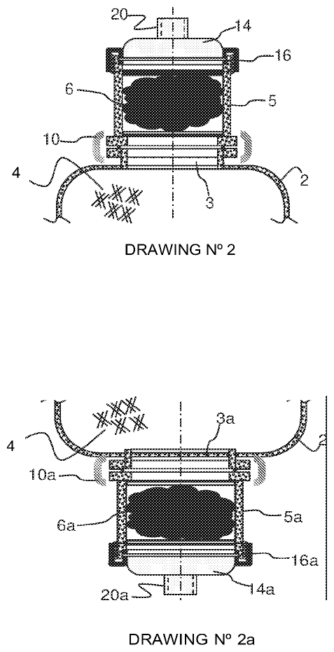

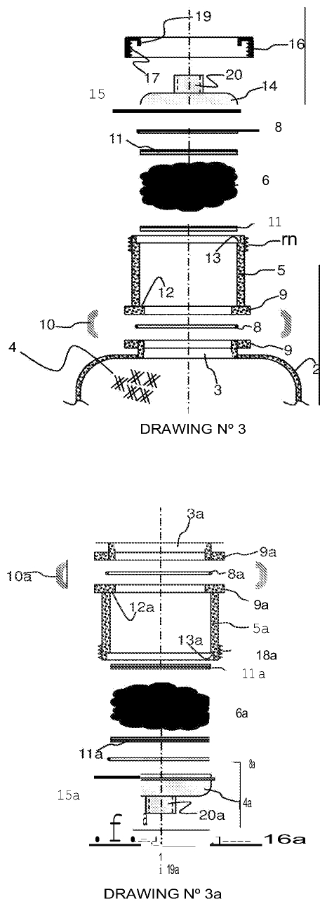

Regarding FIGS. 2 to 3a, both the upper (5) and lower vessels (5a) are identical and have exactly the same parts. The position of each part and its function are explained below:

Both the retention vessel (5) and the opening (3) of the container (2) have a flange (9) that enable them to bind through upper (10) and lower (10a) bolts or jaw clamps. Upper (8) and lower (8a) rubber seals are installed between the upper (9) and lower (9a) bolts and jaw clamps to avoid leakage. Then a circular upper (11) and lower (11a) mesh the same diameter as the inner part of the retention vessels (5) and (5a) is installed and located in the interior upper (12) and lower (12a) outbound perimeter thus preventing the upper (6) and lower (6a) polyester fleece or filter medium to enter the inner part of the container (2). Once the filter medium has been installed (6), another circular upper (11) and lower (11a) mesh is introduced to capture and confine only to the inner part of the upper (5) and lower (5a) retention vessels thus avoiding the filter media (6) and (6a) to be dragged towards the upper water outlet pipe (20) and lower water inlet pipe (20a) corresponding such pipes (20) and (20a) to the upper (14) and lower (14a) lid.

After installing the upper (11) and lower (11a) circular mesh, an upper (8) and lower (8a) rubber seal is installed that will rest over an upper (13) and lower (13a) inner perimetral support forming a seal with an upper (15) and lower (15a) ring, an upper (14) and lower (14a) lid which lower border will trap the circular upper (11) and lower (11a) mesh leaving a compact mass of the upper (6) and lower (6a) filter medium to retain all particulate matter, avoiding the dragging of copper flakes or chips (4) or any foreign material entering the water through the lower (5a) retention vessel located in the lower opening (3a) of the container (2).

After the lid (14) has been installed, the upper (16) locking nut (16) and (16a) is tightened manually. The upper internal notch (19) must be located over the upper (15) and lower (15a) ring pushing and tightening the upper (8) and lower (8a) rubber seal. At that point the retention vessel (5) or (5a) is fully assembled and can be connected to the sterilization system with an upper (20) and lower (20a) connection pipe.

To perform maintenance operations or clean the upper (5) and lower (5a) retention vessel, the upper (20) and lower (20a) connection pipe must be disconnected, the closing screw (16) is rotated, and the lid (14) is removed along with the mesh (11) to clean or change the polyester fleece or filter medium (6).

1. A copper-based water sterilizer device consisting of a container containing small flakes of low thickness pure metallic copper which allows a better disinfection of pathogenic microorganisms in the water and easier maintenance CHARACTERIZED because such container (2) has an upper (3) and lower (3a) central opening both connected to an upper (5) and lower (5a) retention vessel through bolts or using upper (10) and lower (10a) jaw clamps connected to upper (9) and lower (9a) flanges holding in such way the metallic copper flakes or chips (4) to the container (2). An upper (8) and lower (8a) rubber seal is installed between both the upper (10) and lower (10a) jaw clamps to avoid leakage of water. Also a circular upper (11) and lower (11a) circular mesh the same diameter as the inner part of the upper (5) and lower (5a) retention vessels are installed located in an interior upper (12) and lower (12a) outbound perimeter of the retention vessels (5) and (5a) thus preventing the upper (6) and lower (6a) polyester fleece or filter medium from entering through a lower pipe (20a) or coming out through the upper (20) pipe of an upper (14) or lower (14a) lid of the container (2). Also the upper (8) and lower (8a) rubber seal will rest over an upper (13) and lower (13a) inner perimetral support forming a seal with an upper (15) and lower (15a) ring of an upper (14) and lower (14a) lid which lower border will trap the circular upper (11) and lower (11a) mesh leaving a compact mass of the upper (6) and lower (6a) filter medium to retain all particulate matter, avoiding the dragging of copper flakes or chips (4) or any foreign material entering the water through the lower (5a) retention vessel.

2. A copper-based water sterilizer device consisting of a container, according to claim 1, CHARACTERIZED because the upper (14) and lower (14a) lid is connected with an upper (19) and lower (19a) locking nut in such a way an internal upper (19) and lower (19a) notch remains located over the upper (15) and lower (15a) ring pushing and tightening the rubber seal (8).

3. A copper-based water sterilizer consisting of a container, according to claim 1, CHARACTERIZED because the cleaning of the retention vessel (5) requires to disconnect an upper (20) and lower (20a) connection pipe from the upper (20) and lower (20a) lid, the upper (16) and lower (16a) closing lid are rotated and the upper (14) and lower (14a) lid is removed along with the mesh (11) in order to clean or change the polyester fleece or upper (6) and lower (6a) filter medium.
